(19) United States
(12) Patent Application Publication
(10) Pub. No.: US 2019/0287090 A1
(43) Pub. Date: Sep. 19, 2019

(54) METHODS AND SYSTEMS FOR REMITTANCE VIA A SYMBOLOGY

(71) Applicant: PAYCHIEF LLC, New York, NY (US)

(72) Inventors: Andre Gustavo VELLOZO LUZ, Sao Paulo-SP (BR); Mauricio GHETLER, Sao Paulo-SP (BR)

(21) Appl. No.: 16/164,397

(22) Filed: Oct. 18, 2018

Related U.S. Application Data
(63) Continuation of application No. 13/531,334, filed on Jun. 22, 2012, now abandoned.

(51) Int. Cl. G06Q 20/22; H04L 9/32; G06Q 20/32; G06Q 20/10; G09C 5/00

(52) U.S. Cl. CPC G06Q 20/22; H04L 9/3226; G06Q 20/3276; H04L 2209/80; G09C 5/00; H04L 2209/56; G06Q 20/10

(57) ABSTRACT

Methods and systems for transmitting a payment between a plurality of users are disclosed. The methods and systems may perform the following operations: (1) receiving a payment request from a first user; (2) generating data corresponding to the payment request; (3) providing the data to the first user, who creates a symbology encoding the data for delivery to a second user; (4) receiving data encoded by the symbology from a mobile device, wherein the data corresponds to a payment authorization; and (5) transferring funds from a first account to a second account.

### BACKGROUND

Recently, the use of mobile devices, such as smartphones and the like, has rapidly increased. This increase has resulted in part from the porting of technologies to mobile electronic devices that were once limited to non-mobile applications. Mobile technologies provide the promise of a more efficient use of time by allowing interactions with other people and institutions at any time and place. One particular mobile technology demand of consumers is an increased ability to securely manage one's financial situation, such as, for example, transferring funds and other monetary instruments.

Current mobile device technology and the financial services infrastructure to support the technology continues to provide more convenient, secure, and rapid attention to one's financial needs in the mobile environment. However, further development in this field remains necessary to provide rapid transmission of funds between users, which further allows for an instant or almost instant availability of transferred funds. Accordingly, there exists a need for additional secure, easy-to-use systems and methods for transferring funds.

### SUMMARY

In an embodiment, a method of requesting a payment may include (1) receiving, by a computing device, a payment request having information for receiving the payment from a first user; (2) creating, by the computing device, data corresponding to the payment request; and (3) transmitting, by the computing device, the data to the first user, who creates a symbology encoding the data for delivery to a second user.

In an embodiment, a method of requesting a payment may include (1) receiving, by a mobile device, a payment request having information for receiving the payment from a first user; (2) transmitting, by the mobile device, the payment request to a computing device; (3) receiving, by the mobile device, data corresponding to the payment request; (4) creating, by the mobile device, a symbology encoding the data therein; and (5) transmitting, by the mobile device, the symbology to a second user.

In an embodiment, a method for sending a payment may include receiving, by a computing device, data encoded by a symbology corresponding to payment information from a mobile device, and automatically transferring, by the computing device, funds from a first account to a second account according to the payment information.

In an embodiment, a method for transmitting a payment between a plurality of users may include (1) receiving, by a computing device, a payment request from a first user; (2) generating, by the computing device, data corresponding to the payment request; (3) providing, by the computing device, the data to the first user, who creates a symbology encoding the data for delivery to a second user; (4) receiving, by the computing device, data encoded by the symbology corresponding to a payment authorization from a mobile device; and (5) transferring funds, by the computing device, from a first account to a second account.

In an embodiment, a system for transferring a payment may include a processing device and a non-transitory, processor-readable storage medium in communication with the processing device. The non-transitory, processor-readable storage medium may contain one or more programming instructions that, when executed, cause the processing device to (1) receive a payment request from a first user; (2) generate data corresponding to the payment request; (3) provide the data to the first user, who creates a symbology encoding the data for delivery to a second user; (4) receive data encoded by the symbology corresponding to a payment authorization from a mobile device; and (5) transfer funds from a first account to a second account.

### BRIEF DESCRIPTION OF THE DRAWINGS

FIG. 1 depicts a perspective view of a first and second face of a mobile device according to an embodiment.

FIG. 2 depicts a perspective view of a third face of the mobile device in FIG. 1 according to an embodiment.

FIG. 3 depicts a symbology according to an embodiment.

FIG. 4 depicts a block diagram of an illustrative communications system between mobile devices and a computing device according to an embodiment.

FIG. 5 depicts a block diagram of illustrative internal hardware that may be used to contain or implement program instructions according to an embodiment.

FIG. 6 depicts a flow diagram of an illustrative process for sending and receiving funds according to an embodiment.

FIG. 7 depicts a flow diagram of an illustrative process for creating a symbology in accordance with an embodiment.

FIG. 8 depicts a flow diagram of an illustrative process for receiving a symbology input and transferring funds according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processing device and tangible, computer-readable memory. The memory may contain programming instructions that, when executed by the processing device, cause the device to perform one or more operations according to the programming instructions. Examples of electronic devices include personal computers, gaming systems, televisions, and mobile devices.

A “mobile device” refers to an electronic device that is generally portable in size and nature. Accordingly, a user may transport a mobile device with relative ease. Examples of mobile devices include pagers, cellular phones, feature phones, smartphones, personal digital assistants (PDAs), cameras, tablet computers, phone-tablet hybrid devices, laptop computers, netbooks, ultrabooks, global positioning satellite (GPS) navigation devices, in-dash automotive components, media players, watches and the like.

A “computing device” is an electronic device, such as, for example, a computer, a server, or components thereof. The computing device can be maintained by entities such as financial institutions, corporations, governments, and/or the like. The computing device may generally contain a memory or other storage device for housing programming instructions, data or information regarding a plurality of users, such as, for example, contact information, personal information, account information, account balances, account numbers and service login information. The computing device may also have data regarding product inventories, billing information, purchase order information, contracts, bills of sale, and/or the like. The data may optionally be contained on a database, which is stored in the memory or other storage device. The data may optionally be secured by any method now known or later developed for securing data. The computing device may further be in operable communication with one or more electronic devices, such as, for example, the mobile devices described herein. The communication between the computing device and each of the mobile devices may further be secured by any method now known or later developed for securing transmissions or other forms of communication. The computing device may further contain a registry of “authorized users” wherein the authorized users are users that have registered to use the systems and methods described herein. Users may obtain “authorized user” status by, for example, providing contact information, account information, and/or the like.

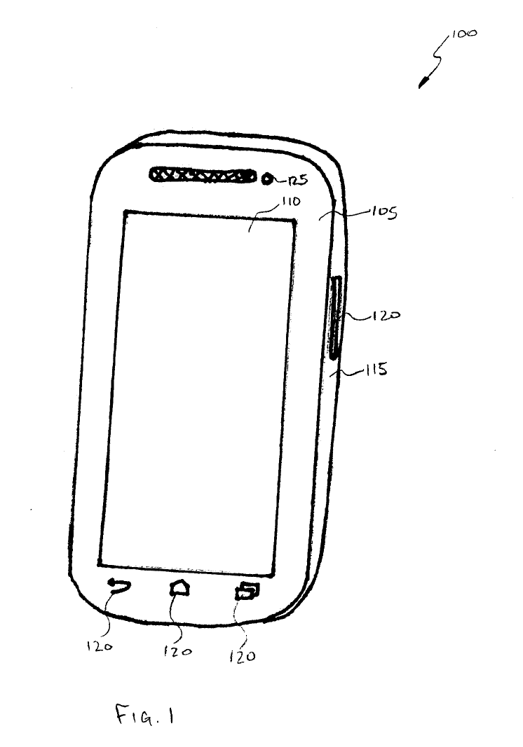

A “symbology” is a pattern, a symbol, an image or the like, as well as portions and combinations thereof, that is displayed on a substrate, such as, for example, the display depicted in FIG. 1. The symbology provides an optical, electronically-readable encoded representation of data. Symbologies can include, without limitation, one-dimensional barcodes, two-dimensional (2D) barcodes, or three-dimensional barcodes. Examples of two-dimensional barcodes include data matrix codes, quick response codes, Aztec codes, Maxi codes and the like. Symbologies can also include letters, numbers, punctuation and other symbols. The symbology may be displayed on a display and may be of any geometric shape or size. In this document, the terms “barcode” or “matrix code” may be used in the examples, but the term is intended to include any type of symbology.

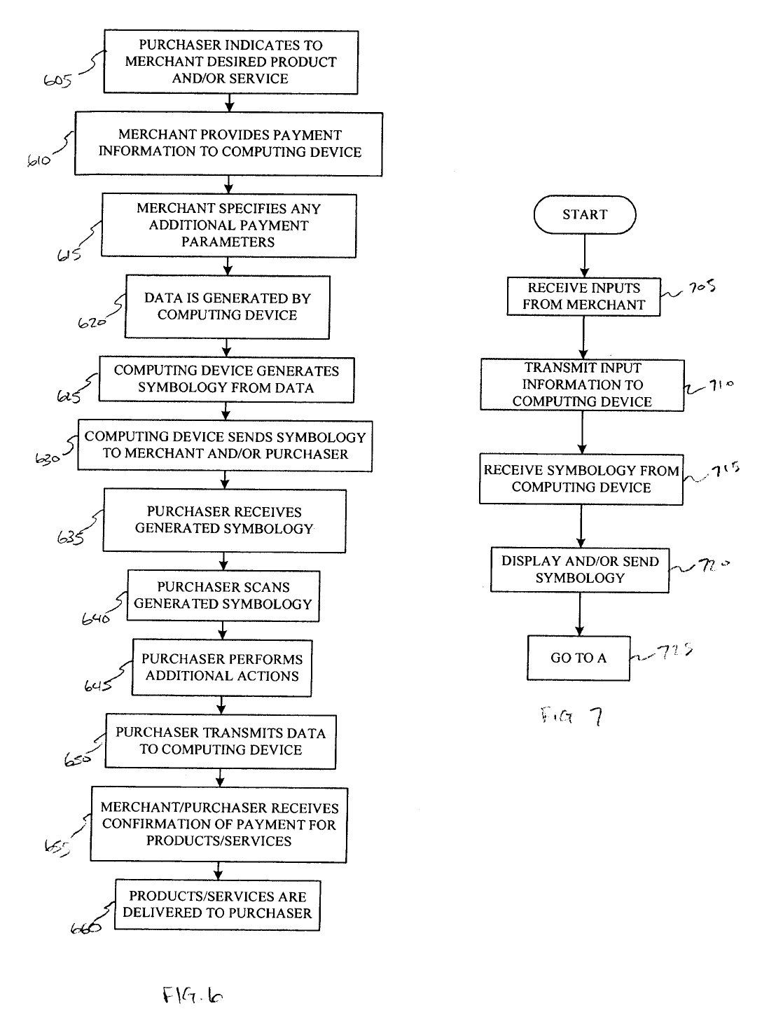

An “application environment” is an embodiment of programming instructions that direct the various components of each mobile device and/or the computing device to execute a plurality of steps, such as those described in more detail in FIGS. 6, 7 and 8. The application environment, when contained in a mobile device, may be referred to as a “mobile application environment.” Similarly, the application environment, when contained in a computing device, may be referred to as a “computing application environment.” The mobile application environment may be a software application or the like, such as a smartphone “app.” The mobile application environment may generally provide a means for reading, decoding, encoding, and communicating the data encoded by a symbology. The computing application environment may generally provide a means for communicating with each mobile device, a means for reading, translating, and transmitting data, and a means for completing other tasks, as described in greater detail herein.

A “beneficiary” is a user that sends a symbology and receives a payment in accordance with an embodiment. The beneficiary can be an individual, a merchant, a corporation, a financial services provider, a government, or any other entity. Conversely, a “benefactor” is a user, such as a person or an entity, that receives a symbology from the beneficiary and sends a payment in accordance with an embodiment. While this disclosure relates generally to a single beneficiary and a single benefactor, those skilled in the art will recognize that multiple beneficiaries and benefactors may be involved in a transaction without departing from the scope of this disclosure. Both the beneficiary and the benefactor must be authorized users to use the application environment, and both must have an account that is recognized as one that is capable of disbursing and/or receiving funds, as described in more detail herein. Examples of accounts are not limited by this disclosure and may include, for example, savings accounts, checking accounts, money market accounts, brokerage accounts, credit accounts, certificates of deposit, electronic wallet accounts and/or pooled accounts wherein funding for the pooled account is obtained from a combination of one or more of the accounts described herein. The accounts may be held with, for example, financial institutions, banks, credit bureaus, building societies, credit unions, trust companies, mortgage loan companies, insurance companies, pension funds, brokers, underwriters and investment funds. The accounts may further contain some form of identifier, such as, for example, an American Bankers Association (ABA) routing transit number (RTN), account numbers, or any other identifier that may be used for identifying a user and/or a user's account.

FIG. 1 depicts a perspective view of a mobile device, generally designated 100, according to an embodiment. The mobile device may have a first face 105 and a second face 115. The first face 105 may have a display 110. The display 110 may generally be a component for displaying images, text, video, and the like. Examples of displays may include, but are not limited to, electroluminescent displays, electronic paper displays, vacuum fluorescent displays, light emitting diode (LED) displays, cathode ray tube (CRT) displays, liquid crystal (LCD) displays, plasma display panels, digital light processing (DLP) displays, and organic light-emitting diode (OLED) displays.

The mobile device 100 may be configured to generate a symbology and/or display the generated symbology on the display 110, as described in more detail herein. The mobile device 100 may generate the symbology by using any methods now known or later developed for creating and encoding symbologies. Alternatively, the mobile device 100 may receive the symbology from another mobile device and/or a computing device.

The mobile device 100 may further have one or more user interface components 120, which may be positioned on any face of the device, including, but not limited to, the first face 105 and the second face 115. The one or more user interface components 120 may generally be configured to elicit one or more commands to the mobile device 100 when actuated. Examples of user interface components 120 may include keypads, switches, buttons and/or the like.

As an alternative to, or in conjunction with the one or more user interface components 120, the display 110 may further include a touch sensitive screen, wherein the touch sensitive screen may act as a user interface component. The touch sensitive screen may receive contact based inputs from a user, such as from a user's fingers. The touch sensitive screen may be adapted for gesture control, thus allowing for a user to tap, pinch, swipe, or provide other similar gestures to elicit commands to the mobile device 100. The touch sensitive screen may further be capable of sending touch commands to the processing device. Examples of touch sensitive screens may include, but are not limited to, resistive touchscreens, capacitive touchscreens, infrared touchscreens and/or other technologies now known or later developed. The mobile device 100 may also be adapted to receive commands via body gestures, voice, audio signals, device movement and/or the like.

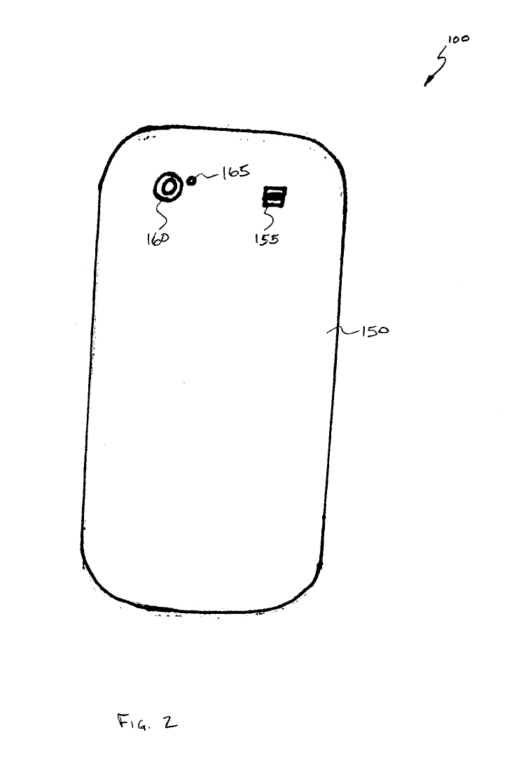

FIG. 2 depicts a perspective view of a third face 150 of the mobile device 100, according to an embodiment. The third face 150 may generally have an optical component 160. The third face 150 may also optionally have an audio component 155 and/or an illumination component 165.

The optical component 160 may be any suitable component capable of receiving an optical image and transmitting image information to other components of the mobile device 100 for processing, such as, for example, a camera. The optical component 160 may further have an ability to adjust its focal length and aperture in such a manner that would allow it to zoom and properly focus upon an intended object to be imaged. Such ability may be through mechanical components (such as an optical zoom) or programming (such as a digital zoom). This adjustment may define an “optimal focal distance,” or a range of distances in which the mobile device 100 may be properly positioned from the intended object to be imaged to achieve a clear image.

While the optical component 160 is depicted on the rear face of the present example, persons skilled in the art will appreciate that the optical component 160 may be positioned at any location on or in any face of the mobile device 100, or may even be external to the mobile device 100 and connected by any means of communication, including, but not limited to, physical cable communication such as universal serial bus (USB), wireless radio communication, wireless light communication, or near field communication technology.

The optical component 160 may further be configured to receive an optical image on the display of another mobile device, such as, for example, a symbology displayed on the display of the other mobile device, as described in greater detail herein.

The optional illumination component 165 may be utilized in any light conditions to assist the optical component 160 in completing any of the tasks described herein. Additionally, the illumination component 165 may be independently activated to turn on or off at specific points in time, such as when additional lighting is necessary to capture an ideal image. Other features of the illumination component 165 may include dimming, strobe, constant on and/or the like.

The illumination component 165 may contain any suitable light source capable of providing illumination, including, but not limited to, magnesium-based flashes, xenon-based flashes, fulminate-containing flashes, light-emitting diode (LED) flashes, and the like. While the present figure depicts the illumination component 165 as being integrated with the mobile device 100, it may be appreciated that the illumination component 165 may be a separate component in communication with the mobile device 100, such as USB based flashes, hot shoe based flashes, remote slave flash units, or other similar devices.

The optional audio component 155 may be adapted to emit audio tones and signals. Such audio tones and signals may be used to instruct the user to complete various steps as described herein, and may further indicate to the user that an image has been received by the optical component 160 by emitting a beep, click, or other audio signal. Additionally, the audio component 155 may be adapted to receive audio signals. Such audio signals may include, for example, voice commands from a user.

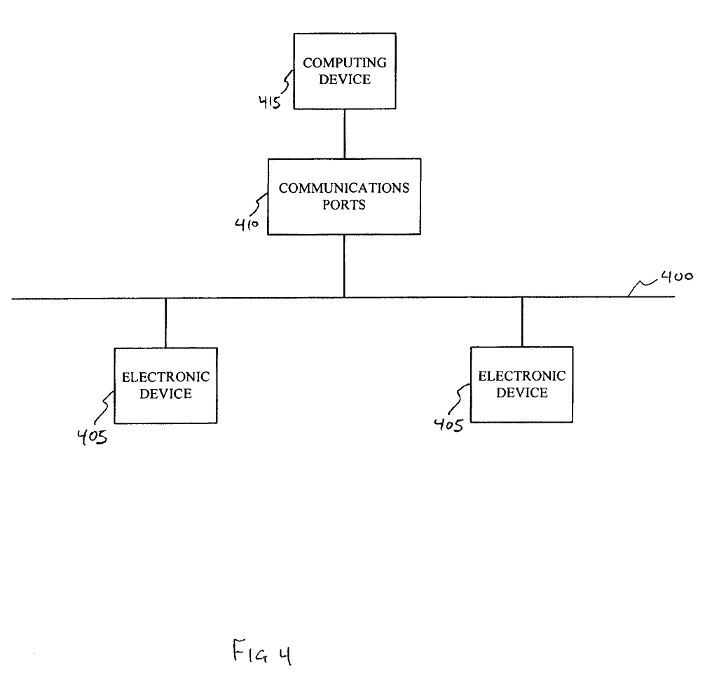

The mobile device 100 may further have an ability to connect to a communications network, as described in FIG. 4 herein. The types of communications networks that may be used in accordance with this disclosure are not limited in any manner, and may include any communications network now known or later developed. For example a communications networks may include, but is not limited to, the Internet, an intranet, a wide area network (WAN), a local area networks (LAN), a wireless local area networks (WLAN), a storage area networks (SAN) and/or the like.

The configuration of the mobile device 100 as shown in FIGS. 1 and 2 is merely an example of a mobile device, and persons skilled in the art will appreciate that other configurations and embodiments will be possible without departing from the scope of this disclosure.

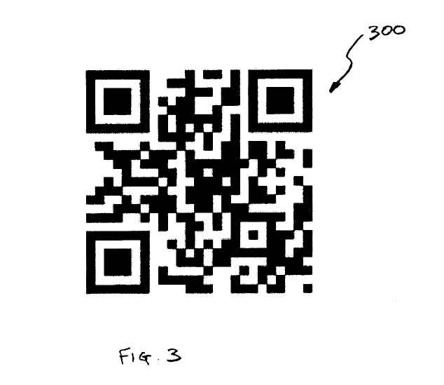

FIG. 3 depicts an example of a symbology, generally designated 300, that may be used in accordance with an embodiment. The symbology 300 may be displayed, for example, on the display 110 of the mobile device 100 (FIG. 1) or affixed to a substrate.

The symbology 300 may be generated by a mobile device 100, or may be generated by any other electronic device, such as for example, a computing device. In instances where the symbology 300 is generated by anything other than the mobile device 100, it may be transmitted to the mobile device 100 for further use, such as for display upon the display 110 (FIG. 1), addition to other documents and/or elements, or for scanning, reading or decoding.

The symbology 300 may be encoded with data that may generally be used by a computing device to gain access to secured information. Examples of secured information may include, but are not limited to, information regarding a user's banking account, an amount of money to be sent and/or received, a date and time of transmission of money for future payments, and/or the like. The symbology 300 may further be encoded with other data, such as, for example, information regarding a product or a service, information regarding a merchant, purchase payment information, information about a bill and purchase order information.

The information encoded in the symbology 300 may further be encrypted. In instances where the information encoded in the symbology 300 is encrypted, the symbology 300 may only be read by certain symbology reading devices and/or applications, such as those that contain or maintain access to an encryption key or another similar means for decrypting the information encoded in the symbology 300. Encryption may be completed by any encryption method now known or later developed. Examples of encryption may include, but are not limited to, manual encryption, transparent encryption, symmetric encryption, asymmetric encryption and the like.

As an alternative to being encrypted, the symbology 300 may be readable by any symbology reading device and/or application. However, the information encoded within the symbology 300 may appear to a user of the symbology reading device and/or application as a random placement of characters, numbers, symbols and the like. However, if the symbology 300 is read using the application environment, the application environment may recognize the characters, numbers, symbols and the like and may perform or complete tasks accordingly, as described in more detail herein.

The symbology 300 may be a standalone image, or may be incorporated within another object, such as, for example, an additional image, text, icons and/or the like. In instances where the symbology 300 is incorporated within another object, the other object may provide at least a portion of the information encoded by the symbology 300.

FIG. 4 depicts a block diagram of communications between one or more electronic devices and one or more computing devices. A communications network 400 may serve as an information highway interconnecting the other illustrated components. The communications network is not limited by this disclosure, and may include any communications network now known or later developed. Examples of communications networks may include, but are not limited to, the Internet, intranets, wired networks and wireless networks. One or more electronic devices 405, such as mobile devices, computing devices and the like may connect to the communications network 400. In embodiments where a plurality of electronic devices 405 are connected to the communications network 400, each electronic device 405 may be configured to communicate with other electronic devices via the communications network 400. A computing device 415 may also be connected to the communications network 400, and may optionally connect through the use of one or more communications ports 410.

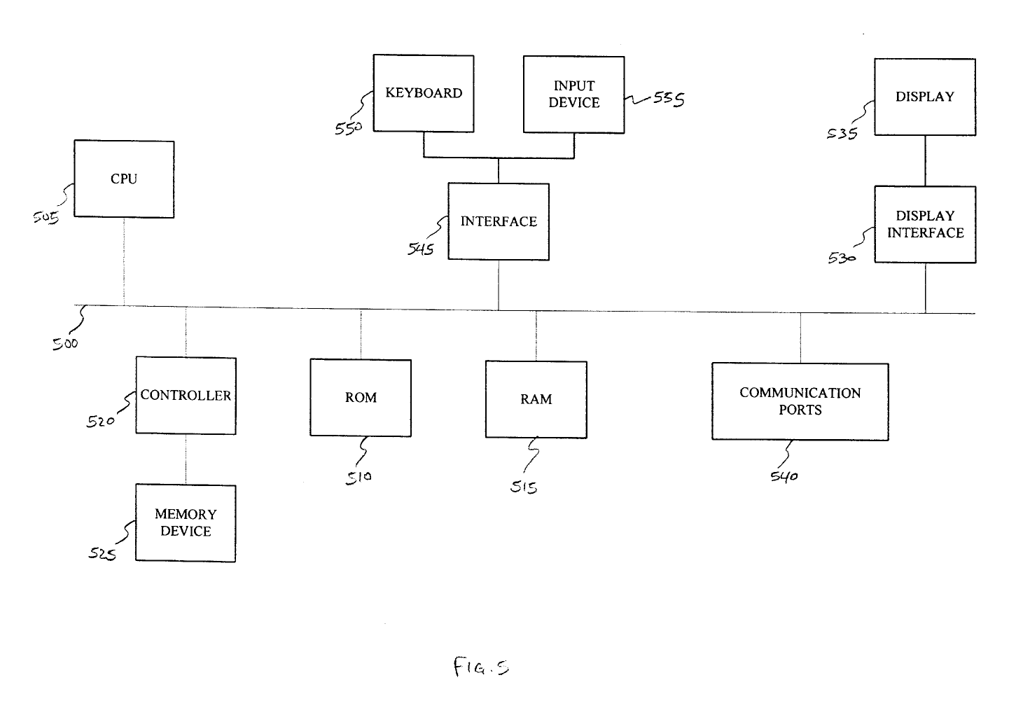

FIG. 5 depicts a block diagram of illustrative internal hardware that may be used to contain or implement program instructions, such as the process steps discussed herein in reference to FIGS. 6-8, according to embodiments. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an illustrative processing device, computing device or processor as such terms are used within this disclosure. Read only memory (ROM) 510 and random access memory (RAM) 515 constitute illustrative memory devices (i.e., processor-readable non-transitory storage media).

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 510 and/or the RAM 515. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 530 may permit information from the bus 500 to be displayed on the display 535 in audio, visual, graphic or alphanumeric format. Communication with external devices, such as a print device, may occur using various communication ports 540. An illustrative communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

FIG. 6 depicts a general process for sending and/or receiving funds according to an embodiment. The process may involve a plurality of users. For the purposes of the present example, two users are depicted; however, more than two users may use the process depicted herein without departing from the scope of this disclosure, such as, for example, instances where a single user requests the same amount of money from two or more other users. The two users in the present example may be a benefactor and a beneficiary. Each user may have an electronic device, as described herein. Each electronic device may have a processor and a memory containing programming instructions in the form of the application environment, such as the mobile application environment.

The beneficiary may access the application environment 605, such as by loading an application on the electronic device, and may specify a payment request, such as by providing an amount desired 610. The amount desired may be an amount agreed upon between the beneficiary and the benefactor, an amount for the purchase of goods and/or services, an amount to pay a bill, an amount for a purchase order, and/or the like. The amount desired may further be any type of funds, financial instruments or currency. Examples of other financial instruments may include, but are not limited to, securities, stocks, bonds, funds, derivative contracts, commodities, and any other fungible, tradable asset. The beneficiary may optionally specify additional parameters 615, such as, for example, a time the funds should be sent, limit options, expiration dates, automatically recurring transfers, identification of goods and/or services to be purchased/sold, information regarding a bill to be paid, information regarding corresponding purchase orders and/or the like.

The mobile application environment may also record information about the mobile device at the time the payment request is entered. Examples of such information may include, but is not limited to, positional coordinates (e.g., GPS coordinates), date and time the payment request took place, the type of mobile device used, user name and password information used to access the application environment, and/or the like. This information may be transmitted to the computing device for storage in the memory at the time the payment request is sent.

The electronic device may take the information obtained from the beneficiary and transmit it to a computing device 620. The computing device may store the information in a memory, and then send data to the beneficiary 625. The data may be, for example, a unique transaction code that identifies the information to the computing device. The transaction code is not limited by this disclosure, and may include any object that may act as an identifier to the computing device. The beneficiary may generate a symbology 630 that encodes the data received from the computing device. Alternatively, the computing device may generate the symbology from the data. Similar to the previous operation, the mobile application environment may record information about the mobile device at the time the symbology is generated. Examples of such information may include, but is not limited to, positional coordinates (e.g., GPS coordinates), date and time the generating took place, the type of mobile device used, user name and password information used to access the application environment, and/or the like. The information may then be transmitted to the computing device for storage in the memory.

Once a symbology has been generated, the benefactor may receive the symbology 635. Delivery of the symbology may be by any means now known or later developed, such as, for example, sending via email, sending via short message service (SMS), sending via multimedia messaging service (MMS), posting to a website, affixing to a bill, affixing to an invoice, affixing to a purchase order and the like. Alternatively, the symbology may be transferred to another medium, such as by printing to a substrate, which may then be delivered to the benefactor.

Once the benefactor has received the generated symbology 635, he/she may scan the symbology 640 to authorize payment. Payment may be automatically authorized and signaled to the computing device, or the benefactor can confirm and manually authorize and signal the computing device. The benefactor may generally display the symbology, such as on a substrate or on a display as disclosed herein, and may scan the displayed symbology. Scanning the symbology may be completed by any means now known or later developed for viewing, reading and/or decoding symbologies. In an embodiment, scanning may be completed through the use of any electronic device, such as, for example, the mobile device depicted in FIGS. 1 and 2. In addition to scanning, the benefactor may optionally complete any other additional tasks 645, such as, but not limited to, sending a message, setting payment terms, confirming payment, identifying goods and/or services to be purchased, submitting a purchase order, identifying one or more bills to be paid and/or the like. The mobile application environment may also record information about the mobile device at the time of scanning, such as, for example, positional coordinates (e.g., GPS coordinates), date and time the scanning took place, the type of mobile device used, user name and password information used to access the application environment, and/or the like.

Upon scanning, the data encoded by the symbology may be transmitted to the computing device 650 for funds transfer. Any other additional information entered by the benefactor and/or information recorded by the mobile application environment may also be transmitted to the computing device, along with the data encoded by the symbology.

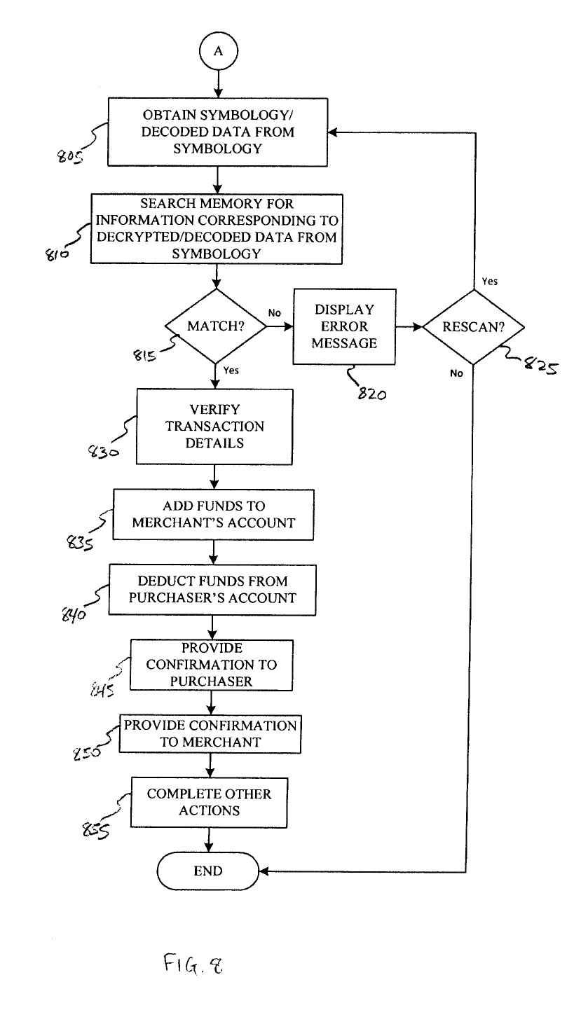

FIG. 7 depicts a process that may be carried out by an application environment in response to inputs received by a beneficiary on an electronic device. The process may first involve receiving a plurality of inputs from a user 705, such as the beneficiary. The inputs may be in the form of a physical interaction with the electronic device containing the application environment, such as touching any number of user interface components, a touch screen and/or the like, as described herein. Alternatively or additionally, the inputs may be in the form of audio commands, gestures, physical movement of the electronic device and/or the like. The plurality of inputs may generally provide information to the application environment regarding the payment, such as, but not limited to, beneficiary information and benefactor information, such as names, account numbers, addresses, telephone numbers and/or the like. The plurality of inputs may further provide other information to the application environment such as, but not limited to, an amount to be transferred, whether it is a recurring payment, whether there is a limit price for the payment, whether there is an applicable time period during which the payment may be sent, whether there is an expiration date for sending payment, whether the payment is for goods and/or services to be rendered, whether the payment is for a bill, whether the payment is for a purchase order and/or the like.

The application environment on the electronic device may transmit the information received from the inputs to the computing device 710. The computing device may store the information in a memory and generate data that corresponds to the stored information. The data may be, for example, a unique transaction code, as described in more detail herein.

The memory may be located in the computing device and may only be accessible via the computing application environment through the use of secure means of communication, such as encrypted communication. Alternatively or additionally, the memory may be in a remote location, such as a remote server, and may only be accessible via the computing application environment through the use of secure means of communication. A portion of the information stored in the memory may be secured and only accessible by the computing device, and a portion may be unsecured and accessible by other devices, such as, for example, one or more of the mobile devices. The secured portion may generally contain sensitive information such as account numbers, account balances, sensitive personal information, and the like. The unsecured portion may generally contain non-sensitive information, such as names, email addresses and the like.

The application environment on the electronic device may optionally receive the data from the computing device 715 and may generate a symbology based upon the data 720. Generation of the symbology may be completed within the mobile application environment, or may be completed in the computing application environment and securely transmitted to the mobile application environment. Generation of the symbology may also involve encoding data that provides an indicator to the computing device to access transaction details.

The symbology may optionally be displayed on the electronic device before it is sent to the benefactor, so as to present the beneficiary with a number of options before sending to the benefactor 725. Examples of options for the beneficiary may include, but are not limited to, reviewing the symbology before sending, providing a personal message to go with the symbology, printing the symbology, delaying the sending, providing invoice and/or bill information, providing bill of sale information and providing information regarding goods and/or services to be rendered. Alternatively, the beneficiary may never see the symbology; rather, it may be automatically sent to the benefactor. Furthermore, the sending may be completed by the mobile application environment and/or the computing application environment. Once the symbology has been sent to the benefactor, the application environment on the benefactor's electronic device may be used to complete a series of steps 730 as depicted in FIG. 8.

FIG. 8 depicts a process that may be carried out by an application environment in response to inputs received by a benefactor on an electronic device. The computing device may obtain the symbology and/or the data encoded by the symbology 805. This may be accomplished by arranging an electronic device in such a manner so as to allow the application environment on the electronic device to scan the symbology received from the beneficiary. Scanning the symbology may be by any method of scanning, as discussed in greater detail herein. The application environment may decrypt and/or decode the symbology to obtain the data encrypted and/or encoded therein 810. The data encrypted and/or encoded in the symbology may contain, for example, an identifier that, when provided to the computing device, acts as an authorization to transfer funds in accordance with the transaction details.

The computing device may search a memory, such as a secure database stored on the secure computing device for information corresponding to the decrypted/decoded identifier data from the symbology 815. A determination may be made as to whether a match exists between the identifier data from the symbology and the information on the database 820. Lack of a match may be due to any number of reasons, and is not limited by this disclosure. Examples of some reasons may include an improper scanning of the symbology, a symbology that is not intended for use in the methods and systems described herein, a symbology that was previously scanned and funds were previously transferred and the like. If a match is not found, the application environment may notify the user of the error 825, and may prompt the user with an option to rescan the symbology 830. If the user chooses to rescan the symbology, the process may repeat 805. If the user does not choose to rescan the symbology, the process may end.

If a match between the identifier and the information stored in the database exists, the application environment may optionally provide the benefactor with a confirmation of the transaction details 835 before the funds are transferred, so as to allow the benefactor to verify the terms of transfer and/or approve the terms of the transfer. The application environment may automatically add funds to the beneficiary's account 840 and at substantially the same time or a short time before or thereafter, deduct the same amount of funds from the benefactor's account 845. In addition to the funds transfer, the application environment may deduct any other amounts, such as transaction fees, or add any other amounts, such as rebates, from the benefactor's account, the beneficiary's account, or both accounts.

The application environment may optionally provide a confirmation to the benefactor 850 and the beneficiary 855. Confirmation may be in the form of a displayed message on the display of the electronic device, an email message, an audio alert, a haptic feedback alert, a telephone call, a mailed printout, a facsimile transmission and/or the like. Alternatively, or in addition, the benefactor and/or the beneficiary may access a source, such as, for example, a website or a customer service phone number, to confirm that payment was sent and/or received.

The application environment may optionally complete one or more additional actions 860. Examples of other actions may include, but are not limited to, automatically sending goods and/or services to the benefactor, marking a bill as paid, confirming payment according to a bill of sale and confirming payment according to a purchase order.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1.-25. (canceled)

26. A system for transferring a payment, comprising:
a processing device; and
a non-transitory, processor-readable storage medium in communication with the processing device, wherein the non-transitory, processor-readable storage medium contains one or more programming instructions that, when executed, cause the processing device to:
receive a payment request from a first user;
generate data corresponding to the payment request;
provide the data to the first user, wherein the first user creates a symbology encoding the data for delivery to a second user;
receive the data encoded by the symbology from a mobile device, wherein the data corresponds to a payment authorization; and
transfer funds from a first account to a second account.

27. The system of claim 26, wherein the first account is associated with the mobile device.

28. The system of claim 26, wherein the one or more programming instructions further comprise one or more programming instructions that, when executed, cause the processing device to provide a payment confirmation comprising a verification that funds have been transferred from the first account to the second account.

29. The system of claim 28, wherein the one or more programming instructions that, when executed, cause the processing device to provide the payment confirmation further comprise one or more programming instructions that, when executed, cause the processing device to provide the payment confirmation to the first user.

30. The system of claim 28, wherein the one or more programming instructions that, when executed, cause the processing device to provide the payment confirmation further comprise one or more programming instructions that, when executed, cause the processing device to provide the payment confirmation to the second user.

31. The system of claim 26, wherein the data comprises a unique identifier that directs the computing device to retrieve detailed payment information.

32. The system of claim 26, wherein the payment request comprises at least one of first user information, second user information, payment amount, payment date and payment expiration.

33. The system of claim 26, wherein the symbology comprises one or more of a multidimensional bar code and a quick response (QR) code.
